(19) United States
(12) Patent Application Publication
(10) Pub. No.: US 2004/0206733 A1
(43) Pub. Date: Oct. 21, 2004

(54) Method and system to drill holes in an electric circuit substrate

(76) Inventors: Dirk Hillebrand, Bruchsal (DE); Hans Juergen Mayer, Viernheim (DE); Daniel Metz, Karlsruhe (DE); Johannes Schuchart, Taipei (TW)

Correspondence Address: HARNESS, DICKEY & PIERCE, P.L.C., P.O.BOX 8910, RESTON, VA, 20195, US

(21) Appl. No.: 10/673,206

(22) Filed: Sep. 30, 2003

(30) Foreign Application Priority Data
Apr. 15, 2003 (DE) 10317363.3

(51) Int. Cl. B23K 26/38; B23K 26/06

(52) U.S. Cl. 219/121.71; 219/121.7; 219/121.74

(57) ABSTRACT

To drill holes in an electric circuit substrate with the help of a laser beam, the drilling being performed by a circular motion of the laser beam within the area of the intended drill hole, the movement of the laser beam is created via two in-line deflection units. The first deflection unit, which preferably contains galvomirrors, triggers the jump of the laser beam from a drill position to the respective next drill position and the centering within the respective drill position. The second deflection unit, which preferable contains piezoelements, modulates a continuous circular motion onto the laser beam. In doing so the laser is only turned on if the first deflection unit is at a standstill.

The present application hereby claims priority under 35 U.S.C. § 119 on European patent application number DE 10317363.3 filed Apr. 15, 2003, the entire contents of which are hereby incorporated herein by reference.

### FIELD OF THE INVENTION

The present invention generally relates to a method to drill holes in an electric circuit substrate with the help of a laser beam, which is focused via a deflection optics unit and an imaging unit on an individual drill position and moved in a circular motion in the area of the intended drill hole. Furthermore the present invention generally relates a system to drill holes in an electric circuit substrate with a laser source, a deflection unit and an imaging unit to focus the laser beam emitted by the laser source onto the relevant drill position of the substrate and to trigger a circular motion of the laser beam in the area of the desired drill hole.

### BACKGROUND OF THE INVENTION

U.S. Pat. No. 5,593,606 already features such a method and system. Here, holes with a larger diameter than the laser beam diameter are created by moving the laser beam either in spiral tracks or in concentric circles within the hole and from the outside to the inside or from the inside to the outside.

With the traditional method, when drilling circuit boards or comparable circuit substrates, the drill hole positions are approached subsequently with the relevant deflection unit. In so doing the laser beam is moved in a jumping motion from an initial position, e.g. a previous drill hole, to the center of the new drill hole and subsequently to the orbit with the pre-set radius and eventually, always using the same deflection unit, moved on this preset orbit one or more times until the desired hole is created. This is followed again by a jumping motion to the next hole position. As a significant change of direction might occur between the individual movement sequences, the user has to wait for a standstill of the deflection unit, which, due to the inertia of the deflection unit, results in a significant time lag compared to the mere processing time of the drill hole. Furthermore the roundness of the drill holes might be affected if the laser is turned on during the transition from a radial movement to a circular movement and turned off again at the end of the circular movement.

### SUMMARY OF THE INVENTION

An object of the present invention is to provide a method and system of the above-mentioned nature to drill holes in an electric circuit substrate, which can improve the quality of the drill holes with regards to their roundness as well as the throughput, i.e. the number of drilled holes per time unit.

The present invention achieves this with the above-mentioned method by,

realizing the movement and the centering of the laser beam axis to the respective drill position via a first deflection unit,

continuously modulating the circular movement onto the laser beam via a second deflection unit that precedes the first deflection unit, and

turning on the laser beam only when the first deflection unit is in a non-motion state.

In the present invention the different movements performed by the deflection unit are thus performed in two different stages, by installing another deflection unit preceding the first deflection unit, which modulates a continuous circular movement onto the laser beam. The traditional deflection unit thus only triggers the jumping motion from one drill position to the next and the positioning in the respective drill position, whereas the circular motion is created by the second deflection unit, which is constantly in motion and thus does not cause time lags by stopping and re-starting the mirroring motion, incurring resulting losses due to inertia. The time period is thus reduced to the jump to the desired drill position and the waiting period until the drill position is reached and the first deflection unit rests. Afterwards the laser is turned off again without any further waiting periods after one or more turns. There are no waiting periods during the start of the circular motion and during the movements from one orbit into the center, as the circular motion continues constantly and the second deflection unit does not experience a stand-still. As there is no change of direction in the beam when reaching or leaving the orbit there not only is no lag, but also no mode burn, which might affect the roundness of the hole.

As both deflection units are controlled separately, their overall control is easier and corrections of the diameters and the speed behavior can be performed independently from each other. In general higher absolute orbital velocities can be achieved. While focusing with the traditional deflection unit always meant a compromise had to be made between small circular movements for drilling and large jumping motions for positioning, the invention allows for an optimization of the first deflection unit targeted toward the jumping motion. Thus faster jumps can be achieved.

The circular movement of the laser beam is preferably created by two overlaying sinusoidal movements, which are out of phase by 90°, of the second deflection unit around two axes perpendicular to one another and to the beam axis. However, these deflections in the second deflection unit can also be created through a combination of various series-connected mirrors. Here, however, the deflection angles of the individual mirrors can be smaller which accordingly can trigger higher speeds.

With a system of the above-mentioned kind this task may be solved by the present invention through the following:

the deflection optics unit has a first deflection unit, which can control jumping motions to the respective drill positions,

the first deflection unit is preceded by a second deflection unit in the optical ray path of the laser, which enables the laser beam to have a continuous circular motion, and

the laser can be turned on for a pre-set number of orbits of the second deflection unit during a standstill of the first deflection unit.

Both deflection units can for example be formed traditionally with pairs of galvanometer mirrors. In particular the second deflection unit is, however, provided in a preferred design in that it is formed by at least one piezoelement. As the deflection angles which can be achieved with piezoelements are generally smaller than the angles which can be achieved with galvoelements, they can be used for the second deflection unit, because here, due to the distance to the imaging unit only a very small angle deflection is necessary and the circle radius for the drilling movement is also much smaller than the deflection which is necessary for the jump of the laser beam from one drill position to another. On the other hand piezoelements allow for higher speeds, so that the combination of galvomirrors for the first deflection unit and piezoelements for the second deflection unit creates an especially advantageous embodiment of the present invention with a very high achievable drilling speed.

Here the second deflection unit can also be formed by two piezoelements which can be twisted around their respective longitudinal, mutually perpendicular axes. In another advantageous design the second deflection unit might be formed by a piezotripod, in which a deflection around two axes is possible and which correspondingly deflects the laser beam. By using an adequately adapted control signal, hystereses of the piezoelements can also be compensated for and higher speeds can thus be achieved.

Further scope of applicability of the present invention will become apparent from the detailed description given hereinafter. However, it should be understood that the detailed description and specific examples, while indicating exemplary embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a schematic presentation of the laser drill system according to the present invention;

FIG. 2 illustrates a simplified presentation of the path of a laser beam in the traditional drill method;

FIG. 3 is a presentation corresponding to FIG. 2, showing the path of a laser beam in the method according to the present invention; and

FIGS. 4 and 5 illustrate modified embodiments of the laser beam deflection system of FIG. 1 with different realizations of the second deflection unit.

### DETAILED DESCRIPTION OF THE EXEMPLARY EMBODIMENTS

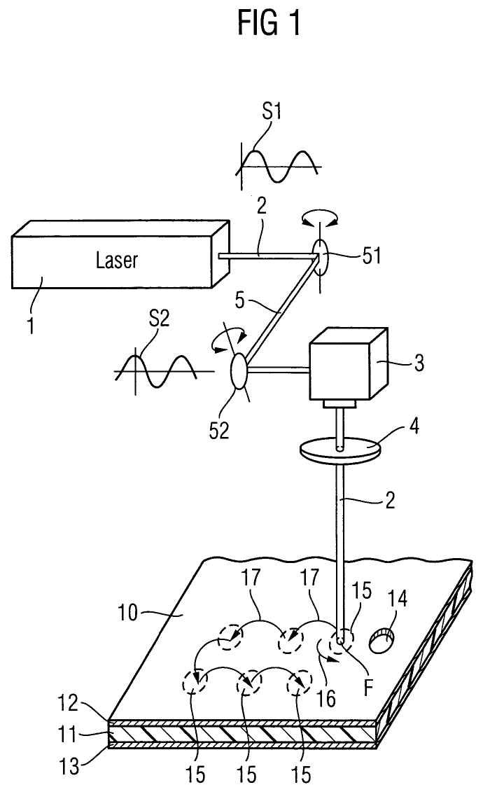

FIG. 1 schematically depicts the order when drilling micro-holes in an electric substrate, preferably a circuit board 10. In doing so the laser beam 2 created by a laser source 1 is conducted via a first deflection unit 3, which can be designed traditionally with galvomirrors, and via an imaging unit in the form of a focusing lens 4 onto the circuit board 10. In this example the circuit board consists of a dielectric layer 11, the top and bottom of which are covered by metallic layers 12 and 13. These metallic layers are structured to form circuit paths (not shown). Furthermore micro-holes 14 are drilled to create electric connections between the top metal layer 12 and the bottom metal layer 13. The walls of these micro-holes are then metallized with the known technique.

To create the micro-holes 14 the laser beam 2 is centered on one of the desired drill positions 15 and then moved via a mode field diameter F, which has been focused in a circle 16 through the focusing lens 4 within the area of this drill position 15, which creates the micro-hole.

Depending on the conditions such as circuit board material, depth of the hole, laser performance and the like the laser beam is moved in one orbit or in various subsequent orbits. To create a feed-through you choose the so-called trepanation method. In this process the laser beam is merely guided along the edge of the hole and the inner core is cut out. When creating micro-holes it might also be necessary to perform various runs of the laser beam with different radii.

As soon as a micro-hole 14 is drilled, the laser beam is deflected in a jumping motion 17 to a next drill position 15, where the circular motion 16 to drill the hole is re-initiated.

The invention is designed so that the traditional deflection unit 3 merely performs the jumping motion 17 of the laser beam with the respective focusing on a drill position 15, whereas the circular motion is modulated onto the laser beam by a pre-ceding second deflection unit 5, which consists of two movable mirrors 51 and 52. These two mirrors 51 and 52 are preferably moved by piezoelements, the deflection axes of which are mutually perpendicular to each other and which perform a continuous sinusoidal oscillation S1 or S2 which is out of phase by 90°.

The laser beam thus continuously moves in an orbit which is pre-focused by the deflection of the second deflection unit 5 and is focused on the desired drill position by the first deflection unit 3. The laser is turned off during the jumping motion 17 of the first deflection unit 3. It is only restarted after the new drill position has been reached and after the first deflection unit has come to a full stop.

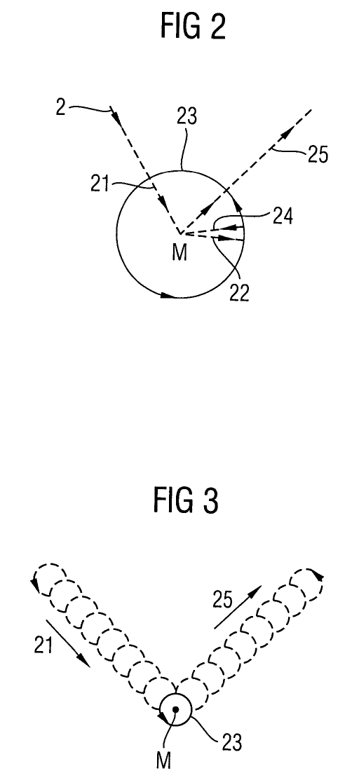

The difference between the traditional and the inventive guiding of the laser beam can be compared in FIGS. 2 and 3. FIG. 2 shows the course of the traditional method. The laser beam 2 or its optical axis is guided in a first movement sequence 21 to the center M of the intended drill hole. From there it is guided—with a more or less significant change of angles—to the movement sequence 22 and the desired circle radius, to be guided in a rectangular change of direction to the circle radius and to perform one or more orbits 23. The laser is only turned on for the orbit 23, whereas it is turned off for the other movement sequences outlined by the broken lines. After the orbit is completed the laser beam is again guided to the center M in movement sequence 24, from where it performs the jump 25 to the next drill position.

In the inventive method—as schematically outlined in FIG. 3—the laser beam performs a modulated, continuous, circular movement through the second deflection unit 5. The deflection unit 3 merely moves the beam via the movement sequence 21 to the desired drill position and subsequently from this drill position via the jumping sequence 25 to the next drill position. The beam itself never moves into the center M of the de-sired drill hole, but rather stays in its orbit and is only turned on within the area of the drill hole, which is depicted in FIG. 3 by the continuous circle. During the jumping sequences 21 and 25 the circular motion is modulated, but the laser stays off during this process.

By uncoupling the two movements and distributing those to the first deflection unit 3 and the second deflection unit 5 the waiting periods become smaller. The only waiting period that remains is the time that the first deflection unit needs to come to rest after the respective jump. Thus the time period for a drill process to create a micro-hole of a potential diameter of 100 μm can be reduced by up to 45%, since there are no longer waiting periods of up to 170 μs.

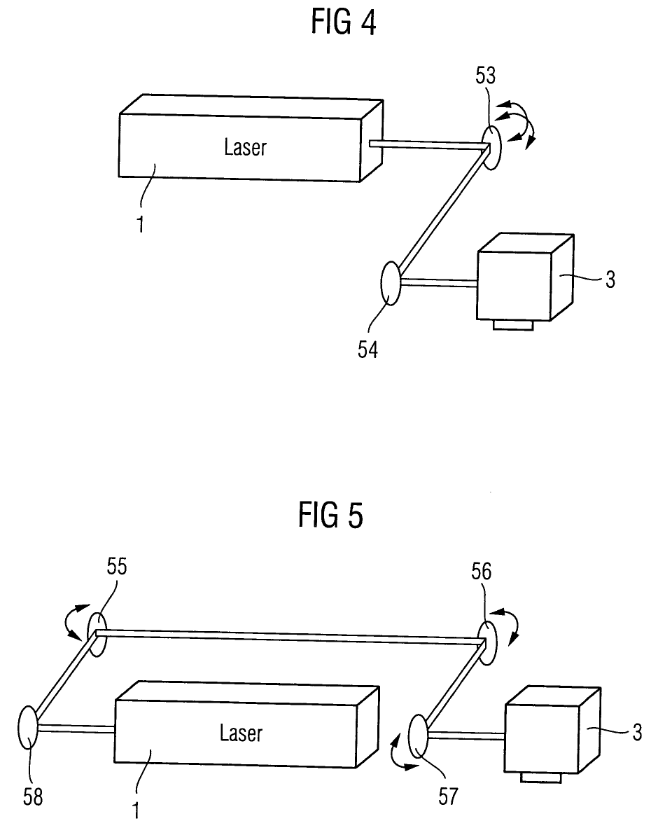

FIGS. 4 and 5 show a comparison to FIG. 1 as to the schematic modifications of the second deflection unit. FIG. 4, for example, points to the option to use a single mirror 53 oscillating around two axes in the second deflection unit, instead of the two mirrors 51 and 52 swiveling around one axis each. In this case the mirror 54 is merely an inflexible deflection mirror.

As the processing diameter is derived from the deflection angle and the distance of the deflection unit to the focusing lens 4, various deflection elements can be used in the same direction of deflection. The smaller this movement, the higher the achievable positioning speed. In FIG. 5 this option is depicted. Here the deflection mirror 55 serves to deflect the laser beam around a first axis, while both mirrors 56 and 57 deflect the laser beam 2 into the same direction with regards to its optical axis, so that their deflection movements sum up. In this case the mirror 58 is an inflexible deflection mirror.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed:

1. A method to drill holes in an electric circuit substrate with the help of a laser beam, which is set via a deflection optics unit and an imaging unit to an individual drill position and subsequently guided within the area of an intended drill hole in a circular movement, the method comprising:
performing movement and centering of the laser beam axis to the individual drill position by way of a first deflection unit;
continuously modulating the circular movement onto the laser beam via a second deflection unit, the second deflection unit preceding the first deflection unit; and
turning on the laser beam when the first deflection unit is at a standstill.

2. The method according to claim 1, wherein the circular movement of the laser beam is created by two overlapping, sinusoidal movements of the second deflection unit, the sinusoidal movements being out of phase by 90°.

3. The method according to claim 1, wherein the deflection in the second deflection unit is created by overlapping more than two individual movements.

4. The method according to claim 1, wherein hystereses for deflection elements are compensated for via a modified control signal for the second deflection unit.

5. A system to drill holes in an electric circuit substrate with a laser source, a deflection optics unit and an imaging unit, to center a laser beam emitted by the laser source to a respective drill position of the substrate and trigger a circular movement within the area of an intended drill hole, comprising:
the deflection optics unit includes a first deflection unit, being guidable to respective drill positions in order to perform jumping motions;
the first deflection unit (3) is preceded by a second deflection unit (5) in the optical laser beam path, which enables the laser beam to perform a continuous circular motion; and
the laser being operable for a preset number of or-bits of the second deflection unit, when the first deflection has come to a standstill.

6. The system according to claim 5, wherein the second deflection unit is formed of at least one piezoelement.

7. The system according to claim 6, wherein the deflection unit is formed of two piezoelements, the two piezoelements being twistable around respective longitudinal, mutually perpendicular axes.

8. The system according to claim 6, wherein the second deflection unit includes one piezotripod.

9. The system according to claim 6, wherein the second deflection unit includes two in-line deflection elements being swivelable around mutually parallel axes to provide for deflection in at least one direction.

10. The method according to claim 1, wherein the deflection in the second deflection unit is created by overlapping more than two individual movements.

11. The method according to claim 2, wherein hystereses for deflection elements are compensated for via a modified control signal for the second deflection unit.

12. The method according to claim 3, wherein hystereses for deflection elements are compensated for via a modified control signal for the second deflection unit.
